(19) United States
(12) Patent Application Publication
(10) Pub. No.: US 2013/0060426 A1
(43) Pub. Date: Mar. 7, 2013

(54) ELECTRIC POWER STEERING CONTROL DEVICE

(71) Applicants: Daiji Watanabe, Kariya-shi (JP); Tomoyuki Hori, Kariya-shi (JP); Motoaki Kataoka, Kariya-shi (JP)

(72) Inventors: Daiji Watanabe, Kariya-shi (JP); Tomoyuki Hori, Kariya-shi (JP); Motoaki Kataoka, Kariya-shi (JP)

(73) Assignee: DENSO CORPORATION, Kariya-city (JP)

(21) Appl. No.: 13/597,642

(22) Filed: Aug. 29, 2012

(30) Foreign Application Priority Data
Sep. 5, 2011 (JP) 2011-192983

(51) Int. Cl. B62D 6/08; G06F 17/00; B62D 5/04

(52) U.S. Cl. 701/42

(57) ABSTRACT

In an electric power steering control device, a target assist torque calculation unit calculates a target assist torque or a target current, and a current control unit calculates a basic current instruction so that an actual current Im flowing in an electric motor becomes equal to the target current. An output of the unit is adjusted on the basis of an output of a stable current compensation unit. The unit uses a transfer function Gi expressed by using a differential operator s of not more than fourth order terms. The unit generates a compensation instruction on the basis of the actual current Im in order to produce stable operation of the entire system. A motor drive unit receives a current instruction adjusted on the basis of the compensation instruction, and controls the current flowing in the electric motor.

### CROSS-REFERENCE TO RELATED APPLICATION

This application is related to and claims priority from Japanese Patent Application No. 2011-192983 filed on Sep. 5, 2011, the contents of which are hereby incorporated by reference.

### BACKGROUND OF THE INVENTION

1. Field of the Invention

The present invention relates to electric power steering control devices used in electric power steering systems with an electric motor to assist the driver's operation to the steering wheel of a motor vehicle.

2. Description of the Related Art

In an electric power steering system equipped with an electric motor for assisting the driver's operation of the steering wheel of a motor vehicle, an electric control unit (ECU) as a control device calculates a magnitude of an assist torque on the basis of various input signals such as a steering torque and a vehicle speed, where the steering torque is applied to the steering wheel by the driver, and transmitted to a steering shaft of the motor vehicle. The ECU drives the electric motor on the basis of the calculation result so that the electric motor generates and outputs an optimum assist torque to be supplied to the steering wheel.

A control mechanism for driving the electric motor in a conventional electric power steering system has a target assist torque calculation unit and a current control unit. The target assist torque calculation unit calculates a target assist torque on the basis of a steering torque detected by a torque sensor. The target assist torque is a target value of the electric motor to assist the steering wheel of a motor vehicle. In other words, the target assist torque calculation unit calculates a target current in order to generate such a target torque in the electric motor. The current control unit detects an actual current which currently flows in the electric motor, and generates a current supply instruction on the basis of the detected actual current. Further, the current control unit outputs the current supply instruction to a drive circuit. The drive circuit drives the electric motor on the basis of the received current supply instruction so that the current in the electric motor approaches the target current. For example, a conventional patent document 1, Japanese patent laid open publication No. 2004-216951, has disclosed such a conventional control mechanism in the electric power steering system.

FIG. 6 is a view showing a basic mechanism of a conventional control mechanism in an electric power steering system 100. The conventional control mechanism has the conventional target assist torque calculation unit 110, the current control unit 120, a motor drive unit 130, and etc.

As shown in FIG. 6, the control mechanism of the conventional electric power steering system 100 is equipped with an electric motor 6 and an electric power steering (EPS) mechanism 140. The electric motor 6 generates an assist torque. The EPS mechanism 140 has the steering wheel and the wheels of a motor vehicle, through which the driver's steering operation applied to the steering wheel is transmitted. Through the description, the control mechanism controls the operation of the electric motor 6 and the EPS mechanism 140 as the control targets.

The EPS mechanism 140 contains a torque sensor and a vehicle speed sensor. The torque sensor detects a steering torque Ts. The vehicle speed sensor detects a vehicle speed V of the motor vehicle. The electric motor 6 is equipped with a rotation sensor. The rotation sensor detects a motor speed ω as a rotation speed of the electric motor 6.

As shown in FIG. 6, a transfer function of the electric motor 6 is expressed by the equation 1/(Ls+R), where L indicates an inductance component of the electric motor 6, and R indicates a resistance component of the electric motor 6.

The conventional target assist torque calculation unit 110 in the conventional control mechanism calculates a target assist torque as a target current on the basis of a steering torque Ts, a vehicle speed V and a motor speed ω. A deviation calculation unit 102 in the conventional control mechanism calculates a current deviation value (or a current difference) between the calculated target current and an actual current Im. The actual current is a current which now flows in the electric motor 6. A current control unit 120 in the conventional control mechanism calculates a current supply instruction on the basis of the calculated current deviation value and transmits the current supply instruction to the driving circuit 130. When receiving the current supply instruction transmitted from the current control unit 120, the drive unit 130 adjusts an electric power to be supplied to the electric motor 6 on the basis of the received current supply instruction. That is, the motor drive unit 130 adjusts the current flowing in the electric motor 6 on the basis of the received current supply instruction.

As shown in FIG. 6, the conventional target assist torque calculation unit 110 has a stable torque compensation unit 111 (or a phase compensation unit), a base assist calculation unit 112, an assist compensation unit 113 and an addition unit 114. The stable torque compensation unit 111 applies a phase compensation to the steering torque Ts in order to make the entire control system (as the control mechanism) stable. The base assist calculation unit 112 multiplies the steering torque which is compensated by the stable torque compensation unit 111 by a predetermined gain Ga (as a proportional term) which corresponds to a current vehicle speed V, and the base assist calculation unit 112 calculates a base assist torque with which the current steering torque approaches the target assist torque. The assist compensation unit 113 calculates various compensation torque values in order to compensate the base assist torque so that the motor vehicle drive stably. The addition unit 114 calculates the final target assist torque (as the target current) by compensating the base assist torque with the various torque values, that is, by adding the various torque values and compensating the base assist torque with the added torque values.

The base assist calculation unit 112 has a map in which the base assist torque values correspond to vehicle speed values V (per 20 km/h) in one to one correspondence, and the base assist torque corresponds to the phase compensation torque. The base assist calculation unit 112 calculates the target assist torque which corresponds to the phase compensation torque and the vehicle sped V by executing a linier interpolation on the basis of the map.

The assist compensation unit 113 calculates various compensation torque values applied through the wheel of the motor vehicle from the road surface, on which the motor vehicle currently runs, in order for the motor vehicle to drive stably.

In a concrete case, after the driver of the motor vehicle turns the steering wheel, a return-force control unit 115 calculates a compensation torque in order to generate a self-aligning torque as a return force applied to the steering wheel. The return force makes a sense in the driver that is pushed back through the steering wheel. A damping control unit 116 calculates a compensation torque with which the steering wheel is returned to an optimum position when the driver releases the steering wheel. The addition unit 114 adds these compensation torques transmitted from the return-force control unit 115 and the damping control unit 116 to the base assist torque in order to generate the final target assist torque. The obtained final assist torque indicates a target current to flow in the electric motor 6. In the following explanation, we will use the target assist torque and the target current as the same meaning.

The current control unit 120 generates an electric power instruction, namely, a current supply instruction to execute a feedback control of the power supply to the electric motor 6 on the basis of the calculated current deviation. The feedback control adjusts the actual current Im which flows in the electric motor 6 to approaches the target current. In a concrete case, the current control unit 120 has a current control part 121 which is a proportional difference (PI) control unit having a proportional unit and an integration unit. The current control part 121 having the proportional unit and the integration unit executes a proportional calculation and an integration calculation of the current deviation value transmitted from the addition unit 102. The current control part 121 in the current control unit 120 calculates the current supply instruction.

The current control part 121 further inputs the actual current Im in addition to the current deviation value. The current control part 121 calculates the current supply instruction while considering the actual current Im. This current supply instruction actually indicates a drive voltage to be supplied to the electric motor 6. That is, the motor drive unit 130 adjusts the power supply to the electric motor 6 on the basis of the current supply instruction, and the current indicated by the current supply instruction thereby flows in the electric motor 6.

The conventional target assist torque calculation unit 110 in the control mechanism of the conventional electric power steering system 100 always calculates the base assist torque by the proportional calculation (on the basis of the map, previously described) of the steering torque Ts executed by the base assist calculation unit 112. That is, the conventional target assist torque calculation unit 110 executes a map calculation by using the input steering torque Ts in order to calculate an assist torque to be generated in the electric motor 6.

However, it is difficult for the conventional control mechanism to produce stable operation of the entire control system by calculating the base assist torque only on the basis of the map of the steering torque Ts. That is, because the electric power steering system has resonance characteristics in general, the electric power steering system easily enters an unstable condition.

In order to produce stable operation of the entire control system, the conventional target assist torque calculation unit 110 in the conventional control mechanism further has the stable torque compensation unit 111. The stable torque compensation unit 111 executes the phase compensation for the steering torque Ts before the calculation using the map.

FIG. 7 is a view showing a frequency response (Bode plot) of the transfer function Gp of the stable torque compensation unit 111. As shown in FIG. 7, the stable torque compensation unit 111 has the gain characteristics in which the magnitude (dB) has approximately 0 dB within a frequency range of 0 to 1 Hz, the magnitude (dB) is decreased within a frequency range of 1 to 10 Hz. Further, the magnitude (dB) is increased within a frequency range of 10 to 10³ Hz, and decreases again within a high frequency range of 10³ to 10⁴ Hz.

The purpose of the stable torque compensation unit 111 is to stabilize the entire control mechanism of the electric power steering system. More specifically, the aim of the stable torque compensation unit 111 is to keep a gain margin and a phase margin in the entire control mechanism. That is, when the gain Ga of the base assist calculation unit 112 is increased in the conventional target assist torque calculation unit 110 without the stable torque compensation unit 111, the gain Ga exceeds a coordinate (−1, j0) (as a critical point) and is diverged on a complex plane in which a frequency loop response of the entire control mechanism is expressed by a vector locus. That is, the vector locus intersects at the left side of the critical point in a negative real axis. Although it is necessary to avoid the gain Ga from being divergent, it is necessary to obtain an optimum assist torque while the gain Ga has a large value.

In order to avoid the previously described conventional problem in which the vector locus intersects at the left side of the critical point in a negative real axis and in order to have a large gain margin and a large phase margin, the conventional electric power steering system is equipped with the stable torque compensation unit 111 in the conventional target assist torque calculation unit 110 shown in FIG. 6 which adjusts the steering torque Ts in a phase compensation.

FIG. 8 is a view showing one example of a frequency response (Bode plot) of the steering torque Ts detected by the torque sensor, where the steering torque Ts corresponds to the torque of the steering wheel provided by the driver of the motor vehicle.

In FIG. 8, the alternate long and short dash lines indicate the waveforms of the frequency response when the conventional target assist torque calculation unit 110 in the conventional control mechanism has not the stable torque compensation unit 111. On the other hand, the solid lines indicate the waveforms of the frequency response when the conventional target assist torque calculation unit 110 in the conventional control mechanism has the stable torque compensation unit 111.

In FIG. 8, reference characters G0, G3, G6, G9, G12 and G15 indicate the proportional gains Ga of the base assist calculation unit 112 and has a relationship of G0<G3<G6<G9<G12<G15. It can be understood from the gain characteristics shown in FIG. 8 that the more the proportional gains Ga increases, the more the steering torque Ts detected by the torque sensor is decreased, that is, the more the assist torque provided from the electric motor 6 increases.

As shown in FIG. 9, the control mechanism without any stable torque compensation unit 111 has unstable characteristics of the torque sensor to the steering torque, for example, the gain characteristics have the resonance characteristics, as designated by the alternate long and short dash lines in FIG. 8. In other words, the entire control mechanism is unstable when it has not any stable torque compensation unit 111. That is, it can be said that the vector locus of the frequency loop response of the entire control mechanism intersects at the left side of the critical point in a negative real axis.

On the other hand, the control mechanism equipped with the stable torque compensation unit 111 has the optimum characteristics with suppressed resonance characteristics, as designated by the solid lines in FIG. 8. In other words, the entire control mechanism is stable. It can be said that the vector locus of the frequency loop response of the entire control mechanism intersects at the right side of the critical point in a negative real axis. That is, when the conventional target assist torque calculation unit 110 in the conventional control mechanism has the stable torque compensation unit 111, it is possible to change the characteristics of the torque sensor to the steering torque to the optimum characteristics shown in FIG. 8.

However, it is in general very difficult to design the stable torque compensation unit 111 (phase compensation unit) and need to have a long design period of time. In addition to these difficulties, it is difficult to implement the stable torque compensation unit 111 because the transfer function Gp has a higher order. For example, the following complicated equation (1) shows an example of the transfer function Gp used in the stable torque compensation unit 111 having the frequency characteristics shown in FIG. 7.

Gp={55911.4851(s+48.78)(s+274)(s²+71.16s+2542)}/{(s+1036)(s+21.13)²(s²+3808s+4.105e006)} (1).

That is, as shown in FIG. 7, even if the conventional control mechanism is equipped with the stable torque compensation unit 111, it is necessary to have a complicated gain characteristics, temporarily to decrease the gain characteristics and then to increase it. That is, it is difficult to be determined how amount of the gain characteristics is decreased in which frequency band, and also difficult to be determined how amount of the gain characteristics is increased in which frequency band. It needs many design work steps and long period of time for designing the stable torque compensation unit 111.

In addition to the above drawbacks, it is impossible to design the transfer function Gp with a low order. As shown in the complicated equation (1) previously described, it is necessary for more than, fifth order terms at least. Accordingly, it is necessary for the designer to have a high design skill and it needs to many working steps and a long period of time.

### SUMMARY

It is therefore desired to provide an electric power steering control device having a control mechanism with a compensation function to provide stable operation of the entire control mechanism with a simple structure.

The inventors of the present invention have considered the control mechanism of the conventional electric power steering system previously described. It can be noticed that the conventional target assist torque calculation unit and the conventional current control unit have the fixed function, respectively. In particular, the conventional control mechanism uses the actual current, which currently flows in the electric motor 6, in the current feedback control only. This means that the conventional control mechanism uses the actual current Im in order to follow the target current only, like a known current feedback control in various electric motors.

Electric motors used in electric power steering systems are special motors when compared with usual electric motors used in vehicles. For example, an electric motor used in an electric power steering system has a complicated, motion which frequently changes its rotation direction and an assist torque to be generated. However, the conventional control mechanism used in the conventional electric power steering systems executes the current feedback control like the usual motion control.

In order to solve the above conventional problems, the present invention effectively uses the information regarding the actual current flowing in the electric motor.

In views of the difficulty to effectively use of information regarding the actual current and to design and implement the conventional stable torque compensation unit 111 (or the phase compensation unit) previously described, the present invention uses the compensation unit to produce stable operation of the entire electric power steering system by using the information regarding the actual current, instead of using the phase compensation unit in the control block to calculate the target assist torque.

An exemplary embodiment provides an electric power steering control device mounted to an electric power steering system. The electric power steering system has an input shaft 3, an input transmission unit 6a, 5, 7, 8 and 9, a steering torque detection unit 4 and an electric motor 6. The input shaft 3 is connected with a steering wheel 2 of a motor vehicle and rotating with the steering wheel 2. The input transmission unit 6a, 5, 7, 8 and 9 transmits a rotation of the input shaft 3 to wheels 10 of the motor vehicle in order to steer the wheels 10. The steering torque detection unit 4 detects a steering torque which is a torque in a direction of an axial rotation applied to the input shaft 3. The electric motor 6 supplies an assist torque to the input shaft 3 through the input transmission unit 6a, 5, 7, 8 and 9. The electric power steering control device controls the operation of the electric motor 6 in order to control the assist torque. The electric power steering control device has a target assist torque calculation unit 20, a current control unit 120, a stable current compensation unit 31, a current instruction generation unit 32 and a motor drive unit 130. The target assist torque calculation unit 20 calculates a target current to be supplied in the electric motor 6 in order to generate a target torque as the assist torque responding to the steering torque on the basis of the steering torque detected by the steering torque detection unit 4. The current control unit 120 generates a basic instruction in order to adjust the current flowing in the electric motor 6 so that a difference between the target current calculated by the target assist torque calculation unit 20 and an actual current which currently flows in the electric motor 6 becomes zero. The stable current compensation unit 31 generates a compensation instruction in order to compensate the basic instruction and to produce stable operation of the entire electric power steering system 1 on the basis of the actual current. The current instruction generation unit 32 compensates the basic instruction generated by the current control unit 120 with the compensation instruction generated by the stable current compensation unit 31. The current instruction generation unit 32 generates a current instruction to be supplied to the electric motor 6. The motor drive unit 130 drives the electric motor 6 on the basis of the current instruction transmitted from the current instruction generation unit 32. That is, the stable current compensation unit 31 generates the compensation instruction having a transfer function Gi using a differential operator “s” of not more than fourth order terms.

According to the structure of the electric power steering control device, the stable current compensation unit 31 generates the compensation value (as the compensation instruction) on the basis of the actual current, and the current instruction generation unit 32 compensates or adjusts the basic instruction output from the current control unit 120 on the basis of the compensation value generated by the stable current compensation unit 31, instead of obtaining the stable operation of the entire control mechanism by using the phase compensation to the steering torque in the conventional phase compensation unit. It is possible to realize the stable current compensation unit 31 by using the transfer function Gi of not more than the fourth order terms.

That is, the entire control mechanism of the electric power steering system has the stable operation by using the stable current compensation unit 31 of a low order on the basis of the information regarding the actual current. This makes it possible to easily design the control mechanism, in particular, the stable current compensation unit 31 and to provide an easy implementation of the stable current compensation unit 31 into the control mechanism of the electric power steering control device. This makes it possible to drastically decrease the working steps of designing the control mechanism of the electric power steering control device.

In particular, the entire control mechanism indicates the closed loop system comprised of the target assist torque calculation unit 20, the current control unit 120, the stable current compensation unit 31, the motor drive unit 130 and the electric motor 6. The closed loop system is driven on the basis of the target current calculated by the target assist torque calculation unit 20, and the steering torque detected by the steering torque detection unit 4 is feedback to the target assist torque calculation unit 20.

In addition, when the transfer function used in the stable current compensation unit 31 is a fractional function, the transfer function of not more than fourth order of the differential operator “s” indicates that both the numerator and the denominator of the fractional function are the function of not more than fourth order terms of the differential operator “s”.

### BRIEF DESCRIPTION OF THE DRAWINGS

A preferred, non-limiting embodiment of the present invention will be described by way of example with reference to the accompanying drawings, in which:

FIG. 1 is a view showing a schematic structure of an electric power steering system 1 having the electric power steering control device according to an exemplary embodiment of the present invention;

FIG. 2 is a view showing a schematic structure of an internal mechanism as a control mechanism of an electric control unit (ECU) 15 in the electric power steering control device system 1 shown in FIG. 1;

FIG. 3 is a view showing one design model, namely, a control model of a closed loop using a stable current compensation unit 31 in the electric power steering system 1 according to the exemplary embodiment of the present invention;

FIG. 4 is a view showing a Bode plot for expressing frequency characteristics of a transfer function Gi for the stable current compensation unit 31 in the ECU 15 in the electric power steering system 1 according to the exemplary embodiment shown in FIG. 2;

FIG. 5 is a view showing an example of a frequency response (Bode plot) for a “torque sensor characteristics per steering wheel torque” in the electric power steering control device in the electric power steering system 1 according to the exemplary embodiment of the present invention;

FIG. 6 is a view showing a basic mechanism of a conventional control mechanism in an electric power steering system 100;

FIG. 7 is a view showing a frequency response (Bode plot) of the transfer function Gp of the stable torque control unit; and

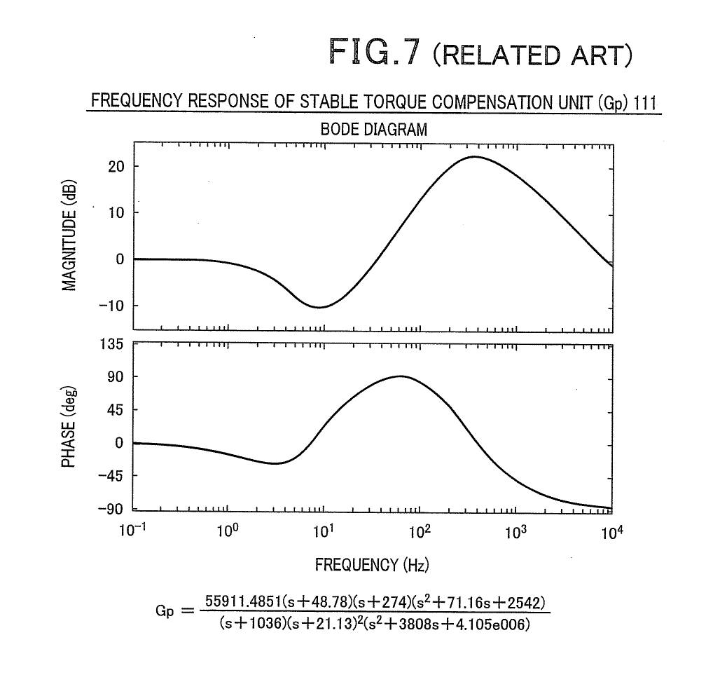

FIG. 8 is a view showing an example of a frequency response (Bode plot) of a steering torque Ts detected by a torque sensor, where the steering torque Ts corresponds to a steering wheel torque which is the torque applied by the driver of a motor vehicle.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

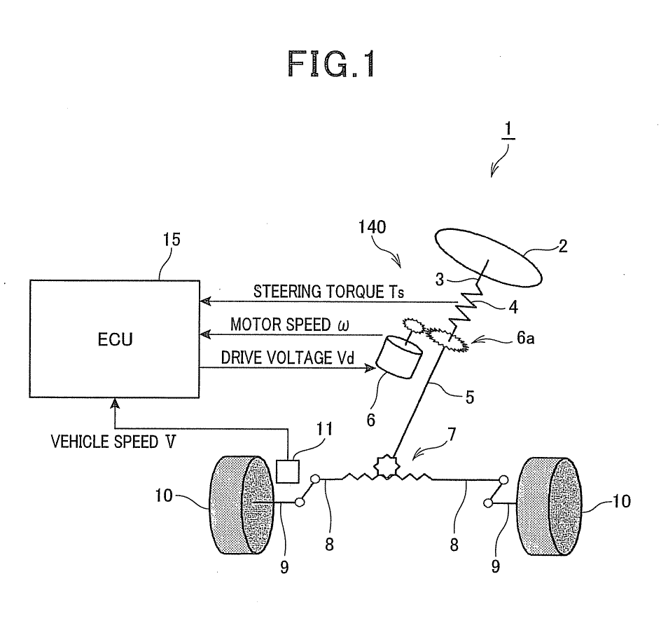

A description will be given of an electric power steering control device in an electric power steering system 1 according to an exemplary embodiment of the present invention with reference to FIG. 1 to FIG. 5.

FIG. 1 is a view showing a schematic structure of the electric power steering control device in the electric power steering system 1 according to the exemplary embodiment of the present invention.

The electric power steering control device according to the exemplary embodiment assists the steering operation of the driver of a motor vehicle by using an electric motor 6. A steering wheel 2 is fixed to one end of a steering shaft 3 (as the input shaft used in the claims). A torque sensor 4 (as the steering torque detection unit used in the claims) is connected with the other end of the steering shaft 3. An end part of the torque sensor 4 is connected with an intermediate shaft 5 (as the input transmission unit used in the claims).

The torque sensor 4 is a sensor to detect a steering torque Ts. Specifically, the torque sensor 4 has a torsion bar. The torsion bar connects the steering shaft 3 with the intermediate shaft 5. The torque sensor 4 detects a torque applied to the torsion bar on the basis of an angle of torsion of the torsion bar.

The electric motor 6 assists (or supports) the steering force of the steering wheel 2. The rotation power of the electric motor 6 is transmitted to the intermediate shaft 5 through a gear reduction mechanism 6a (as the input transmission unit used in the claims). That is, the gear reduction mechanism 6a has a worm gear and a worm wheel. The worm gear in the gear reduction mechanism is fixed to a front end of the rotary shaft of the electric motor 6. The worm wheel is engaged with the worm gear and is coaxially fixed to the intermediate shaft 5. The rotary energy (as the assist torque) of the electric motor 6 is transmitted to the intermediate shaft 5 through the gear reduction mechanism 6a equipped with the worm gear and the worm wheel.

On the other hand, when the intermediate shaft 5 is rotated by the steering operation of the steering wheel 2 by the driver or by a counter force or a reaction force from the road surface on which the motor vehicle currently running, the rotation force of the intermediate shaft 5 is transmitted to the electric motor 6 through the gear reduction mechanism 6a, and the electric motor 6 is rotated by the transmitted counter force.

The exemplary embodiment uses a brushless motor as the electric motor 6. The brushless motor has a rotation sensor such as a resolver. The rotation sensor such as a resolver detects a rotation speed of the electric motor 6 and outputs the detection result. The electric motor 6 used in the exemplary embodiment outputs at least a motor speed ω (which indicates a turning angle velocity as the detection result).

The other end of the intermediate shaft 5, which is the opposite end to the end to which the torque sensor 4 is connected, is connected with a steering gear box 7 (as the input transmission unit used in the claims). The steering gear box 7 is a gear mechanism having a rack and a pinion. As shown in FIG. 1, the pinion gear in the gear mechanism of the steering gear box 7 is fixed to the other end of the intermediate shaft 5. The pinion gear is engaged with the teeth of the rack.

When the driver rotates the steering wheel 2, the intermediate shaft 5 is rotated (that is, the pinion gear is rotated), and the rack is thereby moved to the right or left. Both ends of the rack are fixed to tie rods 8 (as the input transmission unit used in the claims), respectively. The tie rods 8 and the rack move in a reciprocal motion to right and left. This reciprocal motion expands and pushes a knuckle arm 9 (as the input transmission unit used in the claims), and the direction of the tires 10 of the motor vehicle as the vehicle wheels is thereby changed.

A speed sensor 11 is mounted to a predetermined position of the motor vehicle in order to detect the vehicle speed V.

When the driver of the motor vehicle turns the steering wheel 2, the rotation power of the steering wheel 2 is transmitted to the steering gear box 7 through the steering shaft 3, the torque sensor 4 and the intermediate shaft 5. In the steering gear box 7, the rotation power of the intermediate shaft 5 is converted to a right-left motion of the tie rods 8. The movement of the tie rods 8 changes the direction of the tires 10 of the motor vehicle.

The ECU 15 works while receiving electric power supplied from an in-vehicle battery (not shown). The ECU 15 generates a current supply instruction on the basis of the steering torque Ts detected by the torque sensor 4, the motor speed ω of the electric motor 6, the vehicle speed V detected by the vehicle speed sensor 11. When receiving a drive voltage Vd which corresponds to the current supply instruction transmitted from the ECU 15, the electric motor 6 generates an assist torque in order to assist the rotation power of the steering wheel 2 which is handled by the driver of the motor vehicle.

Because the exemplary embodiment shown in FIG. 1 uses a brushless motor as the electric motor 6, the drive voltage Vd supplied to the electric motor 6 by the ECU 15 is three phase voltages Vdu, Vdv, Vdw of the three phases U, V and W. The ECU 15 adjusts the power supply (not shown) of the drive voltages Vdu, Vdv and Vdw to the electric motor 6 in order to adjust the rotation speed of the electric motor 6. Because there are known methods of driving such a brushless motor by using three phase drive voltages (for example, a pulse width modulation (PWM) driving control) and known drive circuits (for example, a three phase bipolar drive circuit), the explanation of these methods and drive circuits is omitted here.

The ECU 15 adjusts the drive voltage Vd to be supplied to the electric motor 6 in order to control the operation of the electric motor 6. That is, because the EPS mechanism 140 is driven through the electric motor 6, the ECU 15 controls the operation of the EPS mechanism 140. In the exemplary embodiment, the EPS mechanism 140 has the entire components other than the ECU 15 and the electric motor 6 in the system configuration shown in FIG. 1. That is, the EPS mechanism 140 contains the entire mechanism in which the steering force of the steering wheel 2 is transmitted to the vehicle wheels 10 of the motor vehicle.

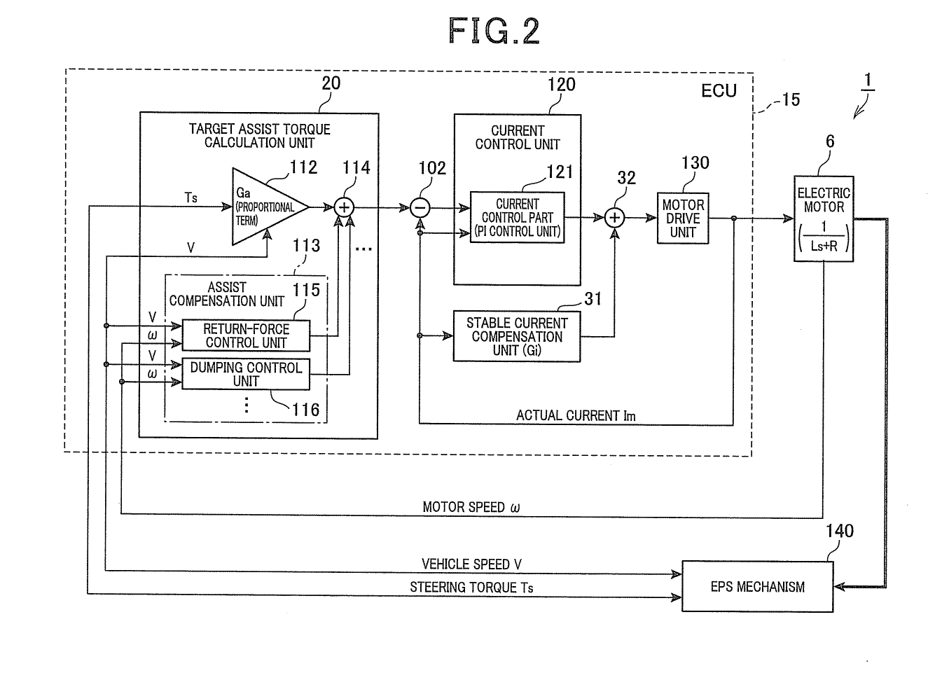

A description will be given of the internal mechanism (as the control mechanism) of the ECU 15 with reference to FIG. 2.

FIG. 2 is a view showing a schematic structure of the internal mechanism (control mechanism) of the ECU 15 in the electric power steering system 1 shown in FIG. 1. The internal mechanism of the ECU 15 does not contain the electric motor 6 and the EPS mechanism 140. That is, the internal mechanism of the ECU 15 has blocks containing a target assist torque calculation unit 20, the current control unit 120 and a motor drive unit 130 other than the electric motor 6 and the EPS mechanism 140, as shown in FIG. 1. In particular, the blocks other than the motor drive unit 130 are realized by programs stored in one or more memory unit (not shown). A central processing unit (not shown) in the ECU 15 executes these programs in order to realize and work the functions of the blocks other than the motor drive unit 130. That is, the blocks in the target assist torque calculation unit 20 and the blocks in the current control unit 120, a stable current compensation unit 31, a current instruction generation unit 32, etc. can be realize by the execution of the various programs. It is also possible to realize the functions of these blocks by hardware such as logic circuits.

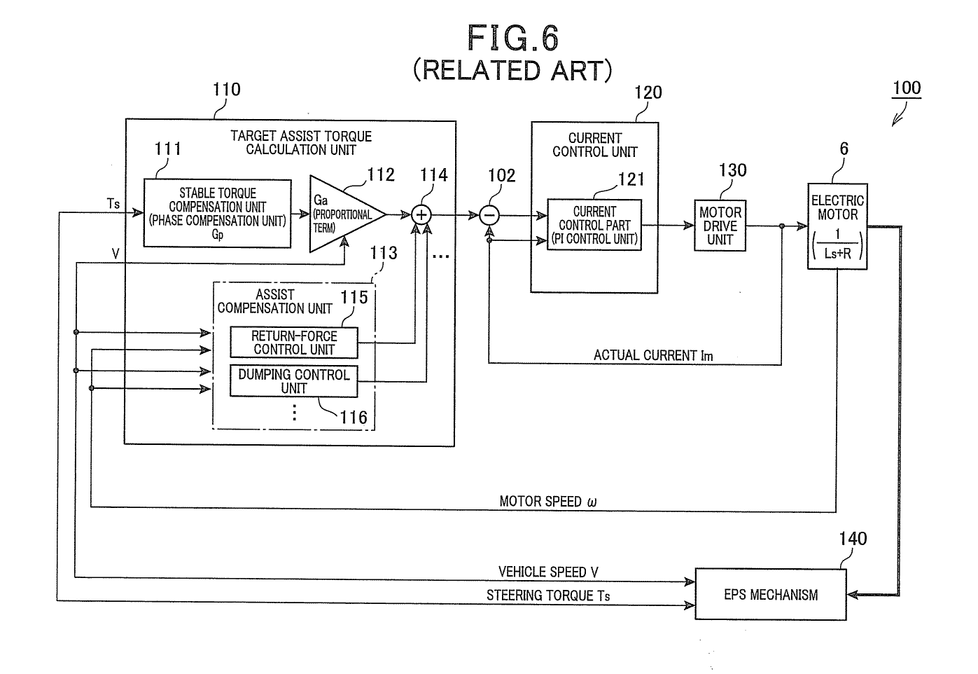

The same components between the control mechanism according to the exemplary embodiment and the conventional control mechanism shown in FIG. 6 will be referred to as the same reference numbers and characters. The explanation of the same components is omitted here.

The improved feature of the components in the control mechanism in the ECU 15 according to the exemplary embodiment will be explained with reference to FIG. 2 to FIG. 5.

As shown in FIG. 2, the ECU 15 has a target assist torque calculation unit 20, the deviation calculation unit 102, the current control unit 120, the stable current compensation unit 31, the current instruction generation unit 32 and the motor drive unit 130.

The target assist torque calculation unit 20 calculates a target assist torque (as a target current) on the basis of a steering torque Ts, a vehicle speed V and a motor speed ω. The deviation calculation unit 102 calculates a current deviation value (or a current difference) between the target current calculated by the target assist torque calculation unit 20 and an actual current Im which currently flows in the electric motor 6.

The current control unit 120 calculates a basic current supply instruction, to be supplied to the electric motor 6, on the basis of the calculated current deviation value and the actual current Im

The stable current compensation unit 31 generates a current compensation instruction in order to produce stable operation of the entire electric power steering system 1 on the basis of the detected actual current Im. The current instruction generation unit 32 adjusts the basic current supply instruction calculated by the current control unit 120 on the basis of the current compensation instruction generated by the stable current compensation unit 31. The current instruction generation unit 32 finally outputs the current supply instruction to the motor drive unit 130.

When receiving the current supply instruction transmitted from the current control unit 120, the motor drive unit 130 adjusts an electric power to be supplied to the electric motor 6 on the basis of the received current supply instruction. That is, although the current corresponding to the current supply instruction flows in the electric motor 6, the motor drive unit 130 actually supplies a drive voltage Vd which corresponds to the current supply instruction to the electric motor 6.

A detection circuit is omitted from FIG. 1 and FIG. 2. The detection circuit having a detection element detects an actual current Im which flows in an electric cable from the motor drive unit 130 to the electric motor 6.

A difference in structure between the target assist torque calculation unit 20 according to the exemplary embodiment shown in FIG. 2 and the conventional target assist torque calculation unit 110 shown in FIG. 6 is that the stable torque compensation unit 111 (or a phase compensation unit) is eliminated from the target assist torque calculation unit 20 shown in FIG. 2. Accordingly, the base assist calculation unit 112 in the target assist torque calculation unit 20 calculates and outputs the base assist torque obtained by multiplying the steering torque Ts detected by the torque sensor 4 and a proportional gain Ga only without considering any phase compensation.

Accordingly, if the current control unit 120 executes the current feedback control on the basis of the target assist torque obtained by adjusting the base assist torque, transmitted from the base assist calculation unit 112, with compensation torques by the units 104 and 102, the entire control mechanism will enter an unstable state.

In order to avoid this problem, the target assist torque calculation unit 20 in the control mechanism according to the exemplary embodiment shown in FIG. 2 has the stable current compensation unit 31 in addition to the structure of the target assist torque calculation unit 110 without any stable torque compensation unit 111.

Further, in the exemplary embodiment shown in FIG. 2, the stable current instruction output from the current control unit 120 is adjusted on the basis of the compensation instruction obtained by the stable current compensation unit 31. Specifically, the current instruction generation unit 32 adds the stable current instruction output from the current control unit 120 and the compensation instruction output from the stable current compensation unit 31, and the current instruction generation unit 32 outputs the addition result to the motor drive unit 130. The addition result is the stable current instruction to be supplied to the electric motor 6. (On the other hand, in the conventional electric power steering system 100 shown in FIG. 6, as previously described, the current supply instruction transmitted from the current control unit 120 is directly output to the motor drive unit 130.)

By the way, as previously described, the conventional control mechanism using the stable torque compensation unit 111 (as the phase compensation unit) shown in FIG. 6 needs many working steps and long period of time for the design works because it is difficult to determine how amount of the gain characteristics is decreased in which frequency band, and difficult to determine how amount of the gain characteristics is increased in which frequency band. Further, it is difficult for the conventional control mechanism shown in FIG. 6 to design the transfer function Gp with a low order because it is necessary for more than fifth order terms at least to be present in the complicated equation (1).

In order to avoid the conventional problems, the control mechanism of the electric power steering system according to the exemplary embodiment is equipped with the stable current compensation unit 31 instead of having the stable torque compensation unit 111. The control mechanism shown in FIG. 2 effectively uses the information regarding the actual current Im as the current feedback information in order to obtain the stable operation of the entire electric power steering system.

There can be considered to realize, namely, to design the stable current compensation unit 31. For example, the stable current compensation unit 31 has the transfer function Gi expressed by the following equation (2) having a simple structure.

Gi=(−11237.6849)/(s2+81.35s+4290) (2),

where “s” is a known differential operator.

As can be understood from the equation (2), the stable current compensation unit 31 uses the transfer function Gi expressed by a fractional function in which its denominator is a quadratic function with “s”, and its numerator is a constant value. That is, the control mechanism according to the exemplary embodiment uses the equation (2) with the second order when compared with the complicated equation (1) with fifth order terms used in the conventional control mechanism.

A description will now be given of a design procedure to make the stable current compensation unit 31 in the ECU 15 with the equation (2). The important and final purpose of designing the stable current compensation unit 31 is to obtain the stable operation of the entire control mechanism in the electric power steering system 1.

For example, as well known in the Nyquist stability criterion, it can be considered to determine the stability criterion by intersecting, with the coordinate (−1, J0), the vector locus of the frequency loop response of the entire control mechanism at the right side of the critical point in a negative real axis. It can also be considered to satisfy optimum characteristics in the relationship between the input and the output in the control system. In the latter case, it is necessary for the Nyquist stability criterion to determine this control system stable.

In the design work of the stable current compensation unit 31 in the exemplary embodiment according to the present invention, a base model of the electric power steering system 1 is set at first. The design model is then made by considering the structure of the stable current compensation unit 31 used in the ECU 15 of the electric power steering system 1.

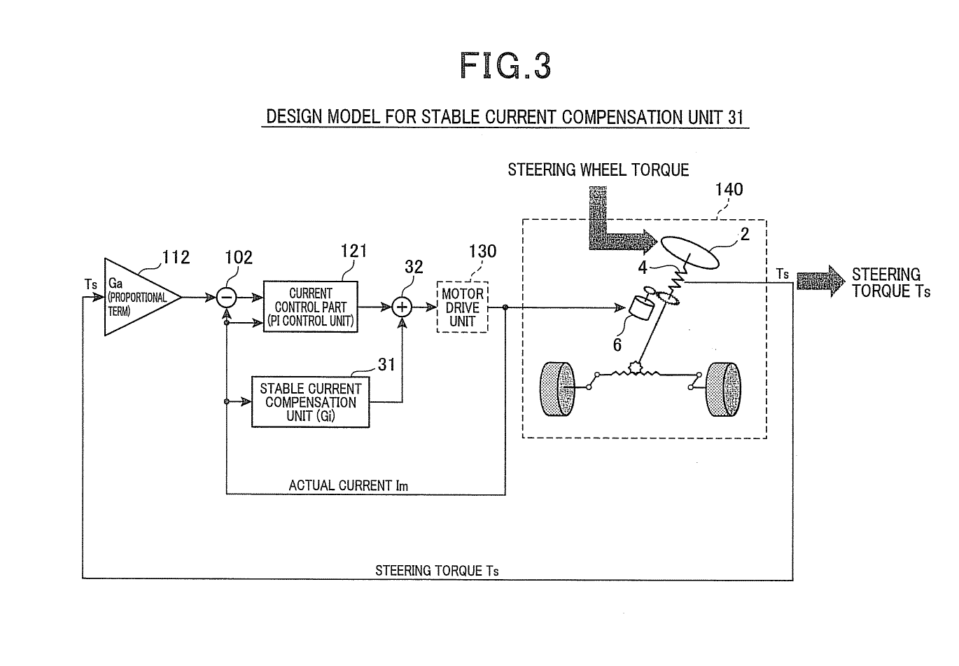

FIG. 3 is a view showing a design model of or a control model of a closed loop using the stable current compensation unit 31 in the electric power steering system 1 according to the exemplary embodiment of the present invention.

That is, FIG. 3 shows a design model of the stable current compensation unit 31 used in the ECU 15 of the electric power steering system 1. The design model shown in FIG. 3 shows a control model of a closed loop having the base assist calculation unit 112 in the target assist torque calculation unit 20, the addition unit 102, the current control part 121, the stable current compensation unit 31 as the target in design, the current instruction generation unit 32 and the EPS mechanism 140 (which contains the electric motor 6).

The design model shown in FIG. 3 uses the fraction function, in which its denominator is a quadratic function with the differential operator “s”, and its numerator is a constant value, as the transfer function of the stable current compensation unit 31. During the design work, various parameters of the transfer function are unknown in general. It is noticed the characteristics of the steering torque Ts to the operation of the steering wheel 2 by the driver of the motor vehicle. This will also be referred to as the “steering wheel torque to torque sensor characteristics”.

The structure of the stable current compensation unit 31 is designed by determining the undetermined parameters of the transfer function so that the “steering wheel torque to torque sensor characteristics” becomes optimum characteristics.

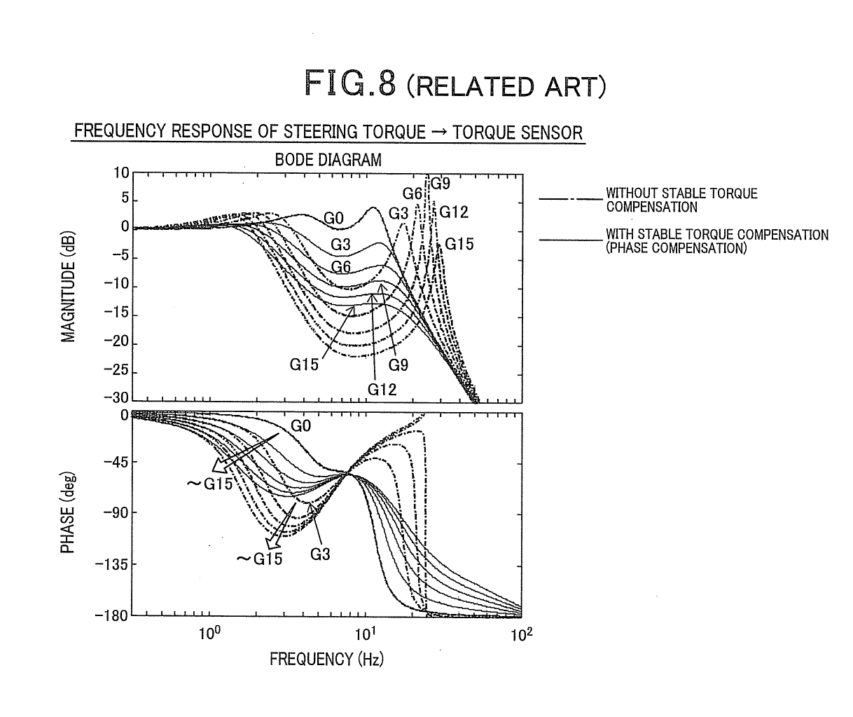

The optimum characteristics for the “torque sensor characteristics per steering wheel torque” are designated by the solid lines, as previously described and shown in FIG. 8. That is, the optimum characteristics are the same characteristics of the “steering wheel torque to torque sensor characteristics” (in more detail, “a frequency response between gain and phase”).

In the ECU 15 of the electric power steering system 1 according to the exemplary embodiment of the present invention, it is therefore necessary to design the stable current compensation unit 31 so that the stable current compensation unit 31 has the same characteristics of the conventional control system equipped with the stable torque compensation unit 111. It is therefore possible for the Nyquist stability criterion to determine that the electric power steering control device of the electric power steering system 1 according to the exemplary embodiment is a stable system.

The design model for designing the stable current compensation unit 31 used in the ECU 15 of the electric power steering system 1 executes the optimization method for determining the various parameters used in the stable current compensation unit 31. That is, the “torque sensor characteristics per steering wheel torque” is adjusted by gradually converging the various parameters so that the “torque sensor characteristics per steering wheel torque” has the optimum characteristics while adjusting the various parameters in the design model shown in FIG. 3. The equation (2) having a simple structure previously described is an example of the transfer function Gi of the stable current compensation unit 31 determined by the optimization method for determining the various parameters used in the stable current compensation unit 31.

There are tools such as a known matrix laboratory (MATLAB) software which is a numerical computing environment in the control computer aided design (control CAD) field to be used for designing the stable current compensation unit 31 on the basis of the optimization method for performing the convergence of the various parameters.

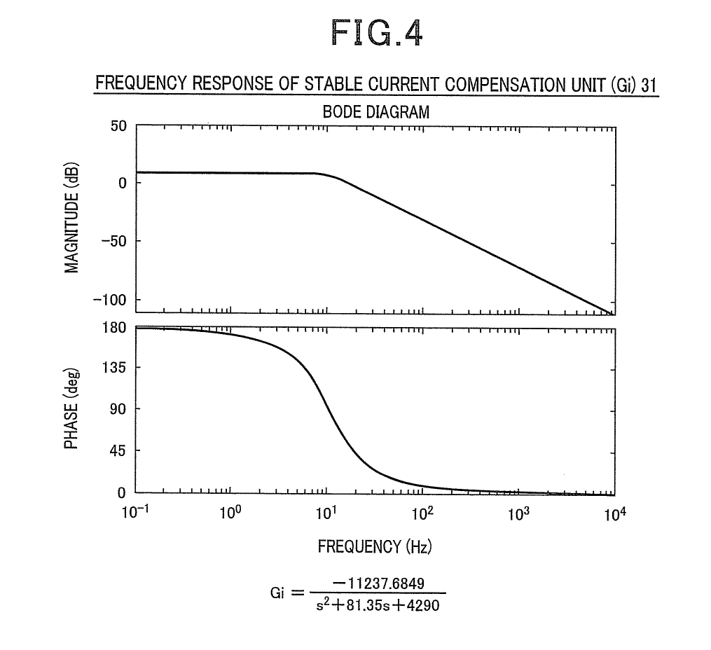

FIG. 4 is a view showing a Bode plot for expressing frequency characteristics of the transfer function Gi (expressed by the equation (2), as previously explained) for the stable current compensation unit 31 used in the ECU 15 in the electric power steering system 1 according to the exemplary embodiment shown in FIG. 2.

As shown in FIG. 4, the transfer function Gi has the characteristics in which the gain characteristics approximately have a constant value in the frequency band of less than 10 Hz (which corresponds to a boundary frequency used in the claims), and is monotonically decreased in the frequency of more than 10 Hz.

On the other hand, the transfer function Gi has the phase frequency in which the more the frequency is changed from 10 Hz toward the zero Hz, the more the phase approaches 180 degrees, and the more the frequency is changed from 10 Hz toward more than 10 Hz, the more the phase approaches zero Hz.

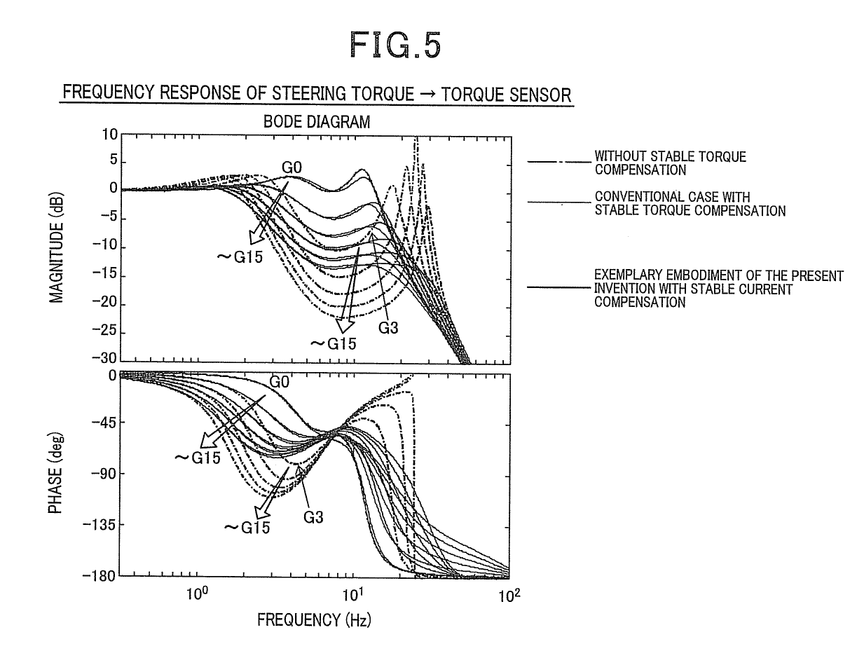

FIG. 5 is a view showing an example of a frequency response (Bode plot) for the “torque sensor characteristics per steering wheel torque” in the electric power steering control device in the electric power steering system 1 according to the exemplary embodiment of the present invention. In FIG. 5, the bold lines show the frequency response of the electric power steering control device according to the exemplary embodiment of the present invention, the thin solid lines show the frequency response of a conventional electric power steering control device, and the alternate thin long and dash lines indicate the frequency response of an electric power steering control device without having any stable current compensation unit 31.

As can be clearly understood from the results shown in FIG. 5, the frequency response of the electric power steering control device with a simple and improved structure, designated by the bold lines, approximately have the same characteristics of the frequency response of the conventional electric power steering control device designated by the solid line. That is, the electric power steering control device with such a simple structure according to the exemplary embodiment of the present invention can make the same function of the “torque sensor characteristics per steering wheel torque” of the conventional electric power steering control device with a complicated structure.

As previously described in detail, in the structure of the electric power steering control device according to the exemplary embodiment of the present invention, the current instruction generation unit 32 adds the output of the stable current compensation unit 31 and the output of the current control unit 120 in order to obtain the stable operation of the entire electric power steering control device.

According to the structure of the electric power steering control device of the exemplary embodiment, it is possible to easily design the stable current compensation unit 31 with a low order using the actual current Im. This makes it possible to decrease the working steps and period of time necessary for designing the control mechanism

In particular, because the stable current compensation unit 31 can be obtained by using the transfer function Gi of a very low order such as the second order, this makes it possible to decrease the number of working steps and the period of time for designing the stable current compensation unit 31 in the electric power steering control device.

Still further, because the stable current compensation unit 31 can be made by using the transfer function of a very low order, it is possible to suppress influence of overflow and underflow even if the ECU 15 executes various fixed-point arithmetic operations, and thereby to obtain the necessary characteristics.

As previously described, the steering shaft 3 corresponds to the input shaft used in the claims. The mechanism at the downstream side (at the wheels 10 side) from the steering shaft 3 in the EPS mechanism 140 corresponds to the input transmission unit used in the claims.

### Modifications

The concept of the present invention is not limited by the exemplary embodiment previously described. For example, it is possible to have the following modifications of the electric power steering control device used in the electric power steering system 1.

For example, the exemplary embodiment uses the optimization method for determining the various parameters used in the stable current compensation unit 31. This is one of the allowable examples for designing the structure of the stable current compensation unit 31.

For example, it is possible to design the stable current compensation unit 31 by using H-infinity control theory. When using the H-infinity control theory, there is a possibility to calculate a transfer function having a high order. In this case, it is possible to change the calculated transfer function having a high order into the transfer function having a low order as low as possible.

The exemplary embodiment shows the equation (2) having a simple structure as the transfer function Gi for the stable current compensation unit 31. The equation (2) is at least an example of the transfer function Gi. It is possible to select various transfer functions and its order. However, in order to reduce the working steps and period of time for designing the stable current compensation unit 31, it is necessary for the transfer function to have terms of not more than fourth order terms, or of lower order if possible.

Further, FIG. 4 shows at least an example of the frequency response of the stable current compensation unit 31. It is not limited for the stable current compensation unit 31 to have various frequency responses so long as the frequency response provides the stable operation of the entire control system.

The exemplary embodiment previously described uses the brushless DC motor as the electric motor 6. This is at least an example, for example, it is possible to use various types of electric motors such as a DC motor with a brush mechanism. When using the DC motor with a brush mechanism, it is possible to detect the motor speed ω by using a rotational sensor such as an encoder, or by detecting a terminal voltage and a motor current of the electric motor, and estimating the motor speed ω on the basis of the calculated terminal voltage and the motor current.

The exemplary embodiment previously described has the electric motor 6 which is equipped with the rotation sensor. Because this is an example only, it is possible to arrange such a rotation sensor to an optional part in the electric power steering control device of the electric power steering system 1, and to select one from various methods how to detect the necessary information (for example, a rotation state of the electric motor 6 such as a motor speed and a rotation angle of the electric motor 6).

When the electric power steering control device uses a DC motor with a brush mechanism as the electric motor 6, it is possible to use the method of estimating the rotation state of the electric motor 6 on the basis of a current flowing in the electric motor 6.

The exemplary embodiment shows the shaft assist mechanism as one type of the electric power steering system 1 in which the electric motor 6 assists the rotation of the intermediate shaft 5. This is an example only. For example, it is possible for the electric power steering system 1 to use various assist mechanisms such as a lack assist mechanism in which the electric motor 6 assists the reciprocating motion of the tie rods 8 (that is, the reciprocating motion of the lack in the steering gear box 7).

### Other Features and Effects of the Present Invention

There are various types of the stable current compensation unit used in the claims, which corresponds to the stable current compensation unit 31 in the exemplary embodiment. From the view point of easy design, it is better to have the transfer function of a low order. For example, the transfer function Gi of the compensation instruction generated by and output from the stable current compensation unit 31 is expressed by using a differential operator″s of not more than fourth order terms. It is preferable that the transfer function Gi used in the stable current compensation unit 31 is expressed by a quadratic function of the differential operator “s”. Further, it is preferable that the transfer function Gi used in the stable current compensation unit 31 is expressed by a fractional function in which a numerator is a quadratic function of the differential operator “s” and a denominator is a constant value.

That is, when the stable current compensation unit 31 is made by using the transfer function expressed by the a quadratic function of the differential operator “s”, it is possible to reduce the design working steps and implementation steps for the control mechanism while maintaining the stable operation of the entire control mechanism of the electric power steering system.

Further, in order to obtain the transfer function of a low order used in the stable current compensation unit 31 capable of providing the stable operation of the entire control mechanism, it is preferable that the transfer function has characteristics in frequency response having a constant gain during a first frequency band which is lower than a boundary frequency, and a monotonically decreased gain during a second frequency band which is higher than the boundary frequency.

Still further, in the viewpoint of the phase characteristics in the frequency response, it is preferable that the transfer function Gi used in the stable current compensation unit 31 has phase characteristics in the frequency response to approach 180 degrees when the frequency is decreased from the boundary frequency to zero Hz, and to approach zero Hz when the frequency is increased from the boundary frequency.

Using the stable current compensation unit 31 having the above frequency characteristics and a simple structure makes it possible to provide the stable operation of the entire control mechanism.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An electric power steering control device mounted to an electric power steering system comprising an input shaft, an input transmission unit, a steering torque detection unit and an electric motor, the input shaft being connected with a steering wheel of a motor vehicle and rotating with the steering wheel, the input transmission unit transmitting a rotation of the input shaft to wheels of the motor vehicle in order to steer the wheels, the steering torque detection unit detecting a steering torque which is a torque in a direction of an axial rotation applied to the input shaft, the electric motor supplying an assist torque to the input shaft through the input transmission unit, the electric power steering control device controlling the operation of the electric motor in order to control the assist torque, the electric power steering control device comprising:
a target assist torque calculation unit for calculating a target current to be supplied in the electric motor in order to generate a target torque as the assist torque responding to the steering torque on the basis of the steering torque detected by the steering torque detection unit;
a basic instruction generation unit for generating a basic instruction in order to adjust the current flowing in the electric motor so that a difference between the target current calculated by the target assist torque calculation unit and an actual current which currently flows in the electric motor becomes zero;
a stable current compensation unit for generating a compensation instruction in order to compensate the basic instruction and to produce stable operation of the entire electric power steering system on the basis of the actual current;
a current instruction generation unit for compensating the basic instruction generated by the basic instruction generation unit with the compensation instruction generated by the stable current compensation unit, and for generating a current instruction to be supplied to the electric motor; and
a motor drive unit for driving the electric motor on the basis of the current instruction transmitted from the current instruction generation unit.

2. The electric power steering control device mounted to an electric power steering system according to claim 1, wherein a transfer function of the compensation instruction generated by and output from the stable current compensation unit is expressed by using a differential operator of not more than fourth order terms.

3. The electric power steering control device mounted to an electric power steering system according to claim 1, wherein the transfer function used in the stable current compensation unit is expressed by a quadratic function of the differential operator.

4. The electric power steering control device mounted to an electric power steering system according to claim 3, wherein the transfer function used in the stable current compensation unit is expressed by a fractional function in which a numerator is a quadratic function of the differential operator and a denominator is a constant value.

5. The electric power steering control device mounted to an electric power steering system according to claim 1, wherein the transfer function used in the stable current compensation unit has characteristics in frequency response having a constant gain during a first frequency band which is lower than a boundary frequency, and a monotonically decreasing gain during a second frequency band which is higher than the boundary frequency.

6. The electric power steering control device mounted to an electric power steering system according to claim 5, wherein the transfer function used in the stable current compensation unit has phase characteristics in the frequency response which approach 180 degrees when the frequency is decreased from the boundary frequency to zero Hz, and to approach zero Hz when the frequency is increased from the boundary frequency.
